(19) United States
(12) Patent Application Publication
(10) Pub. No.: US 2023/0353335 A1
(43) Pub. Date: Nov. 2, 2023

(54) METHOD, REMOTE DEVICE, AND SYSTEM FOR TRANSMISSION COMPATIBLE WITH TWO TYPES OF TDD SWITCH SIGNALS

(71) Applicants: PROSE TECHNOLOGIES (SUZHOU) CO., LTD., Suzhou (CN); PROSE TECHNOLOGIES LLC, Mount Olive, NJ (US)

(72) Inventors: Jing LIU, Suzhou (CN); Wei YANG, Suzhou (CN); Hang ZHANG, Suzhou (CN)

(21) Appl. No.: 18/347,845

(22) Filed: Jul. 6, 2023

Related U.S. Application Data
(63) Continuation of application No. PCT/CN2022/076744, filed on Feb. 18, 2022.

(30) Foreign Application Priority Data
Jun. 11, 2021 (CN) 202110652959.3

(51) Int. Cl. H04L 5/14

(52) U.S. Cl. CPC H04L 5/14

(57) ABSTRACT

A method for transmission compatible with two types of TDD switch signals includes: receiving a downlink TDD switch signal; performing a power-on detection on the downlink TDD switch signal; in response to a successful power-on detection, generating a standard switch signal corresponding to the downlink TDD switch signal; receiving an information of a successful power-on detection and the standard switch signal; comparing the downlink TDD switch signal with the standard switch signal; in response to that a number of abnormal values between the downlink TDD switch signal and the standard switch signal is less than a set value N, outputting a first downlink power switching signal, a first uplink power switching signal, a second downlink power switching signal, and a second uplink power switching signal related to the downlink TDD switch signal.

### RELATED APPLICATION(S)

This application is a continuation application of PCT Patent Application No. PCT/CN2022/076744, filed on Feb. 18, 2022, which claims priority to Chinese Patent Application No. 202110652959.3 filed with the National Intellectual Property Administration, People's Republic of China on Jun. 11, 2021, all of which are incorporated herein by reference in entirety.

### FIELD OF THE DISCLOSURE

The present disclosure relates to signal transmission technology, in particular to a method for transmission compatible with two types of TDD switch signals, a system for transmission compatible with two types of TDD switch signals, and a remote device for transmission compatible with two types of TDD switch signals.

### BACKGROUND

In a simulated indoor distributed system, the synchronization of uplink and downlink time division duplex (TDD) switching time affect the interference suppression capability of the system and the flexibility of the system to support uplink and downlink asymmetric services, thereby affecting other performances of the system. In the simulated indoor distributed system of TDD mode, receiving and sending are performed in different time slots of the same frequency channel (that is, the carrier), and the receiving and sending channels are separated using time. With the increasing demands of users' business capabilities, the signal demands of TDD mode are increasing, and the accuracy requirement of switching of the device standard is also increasing. The TDD switch signal in the general simulated indoor distributed system requires the near-end device to transmit two synchronization signal frame headers of a first signal (for example, 4G signal) and a second signal (for example, 5G signal) through two optical ports respectively to the remote device, the embedded system demodulates the time slot ratio of the synchronization modules and sends it to the remote device, the remote device recovers the respective uplink and downlink power switching signals according to the time slot ratio provided by the embedded system and the received two synchronization signal frame headers.

Certain existing uplink and downlink TDD switch signal transmission technology verifies the generated signal according to the configured parameters, calculates the error of the switch signal after the verification is successful, and performs compensation on the new generated switch signal. After the parameter configuration is completed, the frame header is recognized according to the configured communication standard and the internal time slot ratio setting, and the pulse signal in the time slot is filtered out. That is, when performing verification, it should be known that the configured time slot ratio, the cycle threshold, as well as the cycle of the currently given cycle synchronization signal, that is, the amount of inputs required is relatively large, the implementation of the design is more complicated; and the frame header needs to be recognized to filter out the pulse signal and then compensate and calibrate, whose design is more cumbersome. Therefore, certain existing uplink and downlink TDD switch signal transmission technology increases the optical fiber resources and the complexity of the system, and increases the device cost.

### SUMMARY

With respect to the above problems, the first aspect of the present disclosure proposes a remote device for transmission compatible with two types of TDD switch signals, and the remote device includes: a logic processing unit and an embedded system;
the logic processing unit is configured to receive a downlink TDD switch signal, wherein the downlink TDD switch signal includes a first downlink switch signal and a second downlink switch signal;
the embedded system is configured to:
   perform a power-on detection on the downlink TDD switch signal;
   in response to a successful power-on detection, generate a standard switch signal corresponding to the downlink TDD switch signal;
the logic processing unit is further configured to:
   receive information indicating the successful power-on detection and the standard switch signal;
   compare the downlink TDD switch signal with the standard switch signal;
   in response to that a number of abnormal values between the downlink TDD switch signal and the standard switch signal is less than a set value N, output a first downlink power switching signal, a first uplink power switching signal, a second downlink power switching signal, and a second uplink power switching signal related to the downlink TDD switch signal.

The disclosed system having a simple design can detect the switch signal, perform error correction on the wrong switch signal, and ensure the correctness of the switch signal.

According to an embodiment of the present disclosure, the embedded system is further configured to:
receive a plurality of the downlink TDD switch signals in a first sampling period as a plurality of test downlink TDD switch signals;
determine whether numbers of transition edges of the plurality of test downlink TDD switch signals are equal to each other, and in response to that the numbers of transition edges are equal, generate a signal average value of the plurality of test downlink TDD switch signals, wherein each test downlink TDD switch signal includes multiple high-levels and multiple low-levels, and the signal average value is a set of average values of all high-levels and low-levels in corresponding positions of the plurality of test downlink TDD switch signals;
determine whether a first difference between each test downlink TDD switch signal and the signal average value is lower than a first threshold;
in response to that each first difference between each test downlink TDD switch signal and the signal average value is lower than the first threshold, determine that the power-on detection is successful.

According to an embodiment of the present disclosure, wherein if the power-on detection is successful, the embedded system is further configured to: use the signal average value as the standard switch signal.

According to an embodiment of the present disclosure, the logic processing unit is further configured to:
determine whether a number of all transition edges of the downlink TDD switch signal in a second sampling period is equal to a number of all transition edges of the standard switch signal, and if not, record that there is one abnormal value in the downlink TDD switch signal, wherein the second sampling period and the first sampling period have a same duration;
determine whether a plurality of second differences between each high-level and each low-level of the downlink TDD switch signal in the second sampling period and the corresponding high-level and low-level of the standard switch signal exceed a second threshold value, if the second difference exceeds the second threshold value, record that there is one abnormal value in the downlink TDD switch signal.

According to an embodiment of the present disclosure, the logic processing unit is further configured to:
in response to that the number of abnormal values between the downlink TDD switch signal and the standard switch signal is zero, directly output the downlink TDD switch signal as a downlink power switching signal; or
in response to that the number of abnormal values between the downlink TDD switch signal and the standard switch signal is less than the set value N, output the standard switch signal as the downlink power switching signal.

According to an embodiment of the present disclosure, the logic processing unit is further configured to:
recover an uplink power switching signal according to the downlink power switching signal;
perform operations of turning-on delay and turning-off in advance on the output of the uplink power switching signal and the corresponding downlink power switching signal.

According to an embodiment of the present disclosure, the logic processing unit is further configured to: in response to that the downlink TDD switch signal further includes an identification signal, output the first downlink power switching signal and the second downlink power switching signal of the downlink power switching signal according to the identification signal.

According to an embodiment of the present disclosure, the logic processing unit is further configured to: in response to that the identification signal includes a first identification signal and a second identification signal, output the first downlink power switching signal and the second downlink power switching signal of the downlink power switching signal according to the first identification signal and the second identification signal.

With respect to the above problems, the second aspect of the present disclosure proposes a system for transmission compatible with two types of TDD switch signals, the system including:
the remote device according to the above aspect; and
a near-end device sending a downlink TDD switch signal to the remote device, wherein the downlink TDD switch signal includes a first downlink switch signal and a second downlink switch signal.

With respect to the above problems, the third aspect of the present disclosure proposes a method for transmission compatible with two types of TDD switch signals, the method including:
firstly, providing a remote device, wherein the remote device includes a logic processing unit receiving a downlink TDD switch signal and an embedded system, wherein the downlink TDD switch signal includes a first downlink switch signal and a second downlink switch signal;
secondly, performing a power-on detection on the downlink TDD switch signal by the embedded system;
in response to a successful power-on detection, generating a standard switch signal corresponding to the downlink TDD switch signal by the embedded system;
then comparing the downlink TDD switch signal with the standard switch signal by the logic processing unit; and
in response to that a number of abnormal values between the downlink TDD switch signal and the standard switch signal is less than a set value N, outputting a first downlink power switching signal, a first uplink power switching signal, a second downlink power switching signal, and a second uplink power switching signal related to the downlink TDD switch signal by the logic processing unit.

According to an embodiment of the present disclosure, performing a power-on detection on the downlink TDD switch signal by the embedded system further includes:
receiving a plurality of downlink TDD switch signals in a first sampling period as a plurality of test downlink TDD switch signals;
determining whether numbers of transition edges of the plurality of test downlink TDD switch signals are equal to each other, and in response to that the numbers of transition edges are equal, generating a signal average value of the plurality of test downlink TDD switch signals, wherein each test downlink TDD switch signal includes multiple high-levels and multiple low-levels, and the signal average value is a set of average values of all high-levels and low-levels in corresponding positions of the plurality of test downlink TDD switch signals;
determining whether a first difference between each test downlink TDD switch signal and the signal average value is lower than a first threshold;
in response to that each first difference between each test downlink TDD switch signal and the signal average value is lower than the first threshold, determining that the power-on detection is successful.

According to an embodiment of the present disclosure, generating the standard switch signal corresponding to the downlink TDD switch signal by the embedded system further includes: using the signal average value as the standard switch signal.

According to an embodiment of the present disclosure, comparing the downlink TDD switch signal with the standard switch signal by the logic processing unit further includes:
determining whether a number of all transition edges of the downlink TDD switch signal in a second sampling period is equal to a number of all transition edges of the standard switch signal, and if not, recording that there is one abnormal value in the downlink TDD switch signal, wherein the second sampling period and the first sampling period have a same duration;
determining whether a plurality of second differences between each high-level and each low-level of the downlink TDD switch signal in the second sampling period and the corresponding high-level and low-level of the standard switch signal exceed a second threshold value, if the second difference exceeds the second threshold value, recording that there is one abnormal value in the downlink TDD switch signal.

According to an embodiment of the present disclosure, in response to that a number of abnormal values between the downlink TDD switch signal and the standard switch signal is less than a set value of N, outputting the first downlink power switching signal, the first uplink power switching signal, the second downlink power switching signal, and the second uplink power switching signal by the logic processing unit further includes:
in response to that the number of abnormal values between the downlink TDD switch signal and the standard switch signal is zero, directly outputting the downlink TDD switch signal as a downlink power switching signal; or
in response to that the number of abnormal values between the downlink TDD switch signal and the standard switch signal is less than the set value N, outputting the standard switch signal as the downlink power switching signal.

According to an embodiment of the present disclosure, outputting the first downlink power switching signal, the first uplink power switching signal, the second downlink power switching signal, and the second uplink power switching signal by the logic processing unit further includes:
recovering the uplink power switching signal according to the downlink power switching signal;
performing operations of turning-on delay and turning-off in advance on the output of the uplink power switching signal and the corresponding downlink power switching signal.

According to an embodiment of the present disclosure, outputting the first downlink power switching signal, the first uplink power switching signal, the second downlink power switching signal, and the second uplink power switching signal by the logic processing unit further includes:

in response to that the downlink TDD switch signal further includes an identification signal, outputting the first downlink power switching signal and the second downlink power switching signal of the downlink power switching signal according to the identification signal.

According to an embodiment of the present disclosure, outputting the first downlink power switching signal, the first uplink power switching signal, the second downlink power switching signal, and the second uplink power switching signal by the logic processing unit further includes:
in response to that the identification signal includes a first identification signal and a second identification signal, outputting the first downlink power switching signal and the second downlink power switching signal of the downlink power switching signal according to the first identification signal and the second identification signal.

The method, remote device, and system for transmission compatible with two types of TDD switch signals according to the present disclosure can simplify the structure of the system for TDD switch signal transmission, save fiber resources, and reduce system costs.

### BRIEF DESCRIPTION OF THE DRAWINGS

With reference to the following detailed description and in conjunction with the accompanying drawings, the features, advantages, and other aspects of the embodiment(s) of the present disclosure will become more apparent, several embodiment(s) of the present disclosure are shown by way of example but not limitation here, in the drawing:

FIG. 1 is a schematic structure view of a system for transmission compatible with two types of TDD switch signals according to certain embodiment(s) of the present disclosure;

FIG. 2 is a schematic flow chart of a method for transmission compatible with two types of TDD switch signals according to certain embodiment(s) of the present disclosure;

FIG. 3 is a schematic flowchart of the power-on detection of the method for transmission compatible with two types of TDD switch signals according to certain embodiment(s) of the present disclosure; and

FIG. 4 is a schematic view showing the input and output waveforms of the second downlink switch signal in the system for transmission compatible with two types of TDD switch signals according to certain embodiment(s) of the present disclosure.

### DETAILED DESCRIPTION

In the detailed description of the following embodiment(s), the reference will be made to the accompanying drawings constituting a part of the present disclosure. The appended drawings show specific embodiment(s) capable of implementing the present disclosure by way of example. The exemplary embodiment(s) are not intended to be exhaustive of all embodiment(s) according to the present disclosure. It can be understood that other embodiment(s) can be used, and structural or logical modifications can also be made without departing from the scope of the present disclosure. Therefore, the following detailed description is not restrictive, and the scope of the present disclosure is defined by the appended claims.

The terms “comprising”, “including” and similar terms used herein should be understood as open-ended terms, that is, “comprising/including but not limited to”, which means that other content may also be included. The term “based on” is “based at least in part on”. The term “one embodiment” means “at least one embodiment”; the term “another embodiment” means “at least one another embodiment”, and so on.

The technologies, methods, and devices known to those of ordinary skill in the relevant art may not be discussed in detail, but where appropriate, the technologies, methods, and devices should be regarded as part of the specification. The connection between the units in the drawings is only for convenience of description, which means that at least the units at both ends of the connection communicate with each other, and it is not intended to limit the communication between unconnected units.

The technical problem to be solved by the present disclosure is how to improve the accuracy of the power switching signal output when the demands for TDD mode signals are ever increasing.

To solve the above technical problem, the system for transmission compatible with two types of TDD switch signals disclosed herein includes a near-end device and a remote device. The near-end device is configured to send a downlink TDD switch signal to the remote device. The remote device is configured to receive the downlink TDD switch signal, and perform a power-on detection on the downlink TDD switch signal; in response to a successful power-on detection, generate a standard switch signal corresponding to the downlink TDD switch signal; compare the downlink TDD switch signal with the standard switch signal; in response to that the number of abnormal values between the downlink TDD switch signal and the standard switch signal is less than the set value N, output a first downlink power switching signal related to the downlink TDD switch signal, a first uplink power switching signal related to the downlink TDD switch signal, a second downlink power switching signal related to the downlink TDD switch signal, and a second uplink power switching signal related to the downlink TDD switch signal.

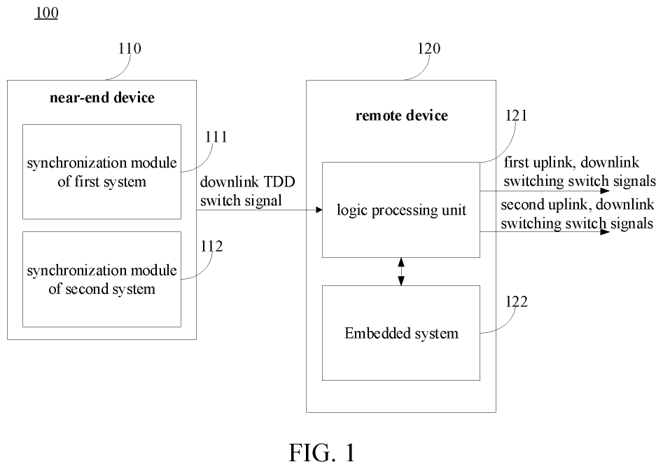

The system, the remote device, and the method for transmission compatible with two types of TDD switch signals are described according to FIGS. 1 to 4 and related embodiment(s).

As shown in FIG. 1, a system 100 for transmission compatible with two types of TDD switch signals includes a near-end device 110 and a remote device 120. In certain embodiment(s), the near-end device 110 includes a synchronization module 111 of a first system and a synchronization module 112 of a second system; the remote device 120 includes a logic processing unit 121 and an embedded system 122.

In this embodiment, the first downlink switch signal generated by the synchronization module 111 of the first system and the second downlink switch signal generated by the synchronization module 112 of the second system are processed via the near-end device 110 to output a downlink TDD switch signal, wherein the downlink TDD switch signal includes a first downlink switch signal and a second downlink switch signal. In certain embodiment(s), the near-end device 110 transmits the first downlink switch signal and the second downlink switch signal to the remote device 120 in a time division manner through an optical fiber interface.

In this embodiment, the first downlink switch signal is optionally a 4G downlink switch signal or other type of downlink switch signal, and the second downlink switch signal is optionally a 5G downlink switch signal or other type of downlink switch signal.

The remote device 120 receives and detects the downlink TDD switch signal, and then outputs the first downlink power switching signal, the first uplink power switching signal, the second downlink power switching signal, and the second uplink power switching signal that are related to the downlink TDD switch signal respectively. As a result, it is possible to realize the transmission compatible with two types of TDD switch signals and the output of the uplink and downlink power switching signals.

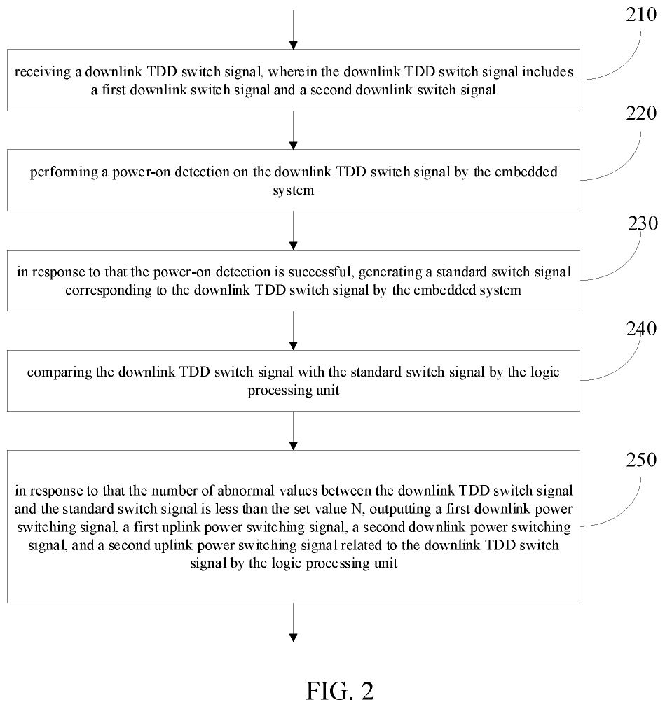

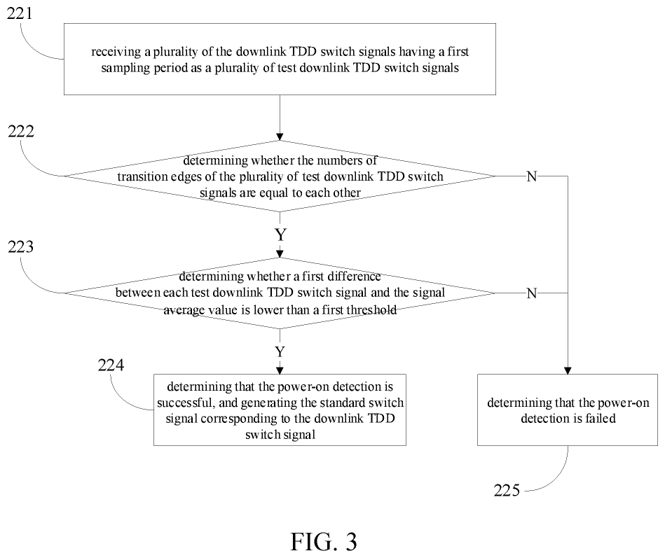

In this embodiment, the remote device 120 implements the method for transmission compatible with two types of TDD switch signals as shown in FIG. 2 and FIG. 3 to realize the above-mentioned functions.

Step 210: the logic processing unit 121 of the remote device 120 receives the aforementioned downlink TDD switch signal.

In certain embodiment(s), when the logic processing unit 121 detects a first valid switch signal rising edge of the downlink TDD switch signal, the counter (for example, Tcount=10 ms, milliseconds) starts to count circularly, the system clock period is Ts, and the clock jitter is Δ, the counter is cleared upon counting to 10 ms/Ts±Δ.

Due to different time slot ratios, the 10 ms radio frame in this embodiment may have a frame with a 5 ms period, a frame with a 2.5 ms period, etc., the number of transition edges can be determined by the logic processing unit 121, and the present disclosure can support various time slot ratio schemes. The counter counts the number of transition edges in each cycle counting period (for example, Tcount=10 ms). The logic processing unit 121 obtains all the high-level lengths and low-level lengths within 10 ms by latching the value of the counter.

The logic processing unit 121 outputs an interrupt signal to the embedded system 122 every cycle counting period, and the embedded system 122 obtains the downlink TDD switch signal in a first sampling period received by the logic processing unit 121 after receiving the interrupt signal (T1st sampling period=10 ms).

Step 220: the embedded system 122 performs a power-on detection on the downlink TDD switch signal. As shown in FIG. 3, this step includes the following:

Step 221: the embedded system 122 receives a plurality of the downlink TDD switch signals in a first sampling period as a plurality of test downlink TDD switch signals.

In certain embodiment(s), the embedded system 122 receives k downlink TDD switch signals in the first sampling period as k test downlink TDD switch signals.

Step 222: the embedded system 122 determines whether the numbers of transition edges of the plurality of test downlink TDD switch signals are equal to each other, and in response to that the numbers of transition edges are equal, generates a signal average value of the plurality of test downlink TDD switch signals.

In this embodiment, the embedded system 122 determines whether the numbers of transition edges of the k test downlink TDD switch signals are equal to each other, and in response to that the numbers of transition edges are equal, generates the signal average value of the k test downlink TDD switch signals.

In this embodiment, each test downlink TDD switch signal includes multiple high-levels and multiple low-levels, and the signal average value is a set of average values of all high-levels and low-levels in corresponding positions of the k test downlink TDD switch signals. For example, a first test downlink TDD switch signal includes four high-levels denoted as A1, A2, A3, and A4 and four low-levels denoted as a1, a2, a3, and a4; and a second test downlink TDD switch signal includes four high-levels denoted as B1, B2, B3, and B4 and four low-levels denoted as b1, b2, b3, and b4. The signal average value includes a set of 4 average high-levels: (A1+B1)/2, (A2+B2)/2, (A3+B3)/2, and (A4+B4)/2, and a set of 3 average low-levels: (a1+b1)/2, (a2+b2)/2, (a3+b3)/2, and (a4+b4)/2. In some embodiments, a quantity high-levels is the same as a quantity of low-levels in a test downlink TDD switch signal. When the quantities of high-levels and low-levels is not the same, the system may restart a synchronization process.

Step 223: the embedded system 122 determines whether a first difference between each test downlink TDD switch signal and the signal average value is lower than a first threshold.

In certain embodiment(s), the embedded system 122 determines whether the first difference between each test downlink TDD switch signals of the k test downlink TDD switch signals and the aforementioned signal average value is lower than the first threshold.

Step 224: in response to that the first difference between each test downlink TDD switch signal and the signal average value is lower than the first threshold, the embedded system 122 determines that the power-on detection is successful.

In addition, as shown in step 225 of FIG. 3, in response to that in step 222, the embedded system 122 determines that the numbers of transition edges are not equal to each other or the first difference between any test downlink TDD switch signal and the signal average value is not lower than the first threshold, the embedded system 122 determines that the power-on detection is failed.

In this embodiment, when the logic processing unit 121 receives the power-on detection failure signal sent by the embedded system 122, the logic processing unit 121 continues to send an interrupt signal and the test downlink TDD switch signal to the embedded system 122; if the embedded system 122 has not sent the information indicating the successful power-on detection to the logic processing unit 121 for a long time, the logic processing unit 121 determines that the synchronization module 111 of the first system and/or the synchronization module 112 of the second system are failed, and the power-on detection process is performed again after the synchronization module 111 of the first system and/or the synchronization module 112 of the second system are synchronized normally.

Step 230: in response to that the power-on detection is successful, the embedded system 122 generates a standard switch signal corresponding to the downlink TDD switch signal, and sends the standard switch signal to the logic processing unit 121.

In this step, the embedded system 122 sends a power-on detection success signal to the logic processing unit 121, so that the logic processing unit 121 stops outputting the interrupt signal; meanwhile the embedded system 122 sends the standard switch signal to the logic processing unit 121.

In this embodiment, the embedded system 122 uses the signal average value as the standard switch signal.

Next, the logic processing unit 121 synchronously outputs the downlink TDD switch signal, as follows:
Step 240: the logic processing unit 121 compares the downlink TDD switch signal with the standard switch signal;
In this step, the logic processing unit 121 receives the information of the successful power-on detection and the standard switch signal;

First, the logic processing unit 121 determines whether the number of all transition edges of the downlink TDD switch signal in the second sampling period (T2nd sampling period=10 ms) is equal to the number of all transition edges of the standard switch signal, if not, records that there is one abnormal value in the downlink TDD switch signal. The second sampling period and the first sampling period have the same duration. In this embodiment, T1st sampling period=T2nd sampling period=10 ms.

Second, the logic processing unit 121 determines whether a plurality of second differences between each high-level and each low-level of the downlink TDD switch signal in the second sampling period and the corresponding high-level and low-level of the standard switch signal exceed a second threshold value, if a second difference exceeds the second threshold value, records that there is one abnormal value in the downlink TDD switch signal.

In certain embodiment(s), when a difference (that is, the second difference) between any high-level of the downlink TDD switch signal in the second sampling period and the corresponding high-level of the standard switch signal exceeds the second threshold, an abnormal value is recorded; alternatively, when a difference (that is, the second difference) between any low-level of the downlink TDD switch signal in the second sampling period and the corresponding low-level of the standard switch signal exceeds the second threshold, and then another abnormal value is recorded.

Step 250: in response to that the number of abnormal values between the downlink TDD switch signal and the standard switch signal is less than the set value N, the logic processing unit 121 outputs a first downlink power switching signal, a first uplink power switching signal, a second downlink power switching signal, and a second uplink power switching signal related to the downlink TDD switch signal. Step 250 as follows:

When the number of abnormal values between the downlink TDD switch signal and the standard switch signal is zero, the downlink TDD switch signal is directly output as the downlink power switching signal.

Alternatively, when the number of abnormal values between the downlink TDD switch signal and the standard switch signal is less than the set value N, the standard switch signal instead of the downlink TDD switch signal which generates abnormal value(s) is output as the downlink power switching signal.

The logic processing unit 121 first recovers an uplink power switching signal according to the downlink power switching signal; then performs operations of turning-on delay and turning-off in advance on the output of the uplink power switching signal and the corresponding downlink switch signal.

In the present disclosure, to prevent the uplink and downlink power switching signals from being turned on simultaneously to form interferences, the approach of turning-off before turning-on is adopted near the uplink-downlink switching point. At the switching point from the end of the downlink time slot to the beginning of the uplink time slot, the downlink power switching signal is turned off in advance and then the uplink time slot power switching signal is turned on after a period of delay. At the switching point from the end of the uplink time slot to the beginning of the downlink time slot, the uplink power switching signal is turned off in advance, and then the downlink time slot power switching signal is turned on after a period of delay.

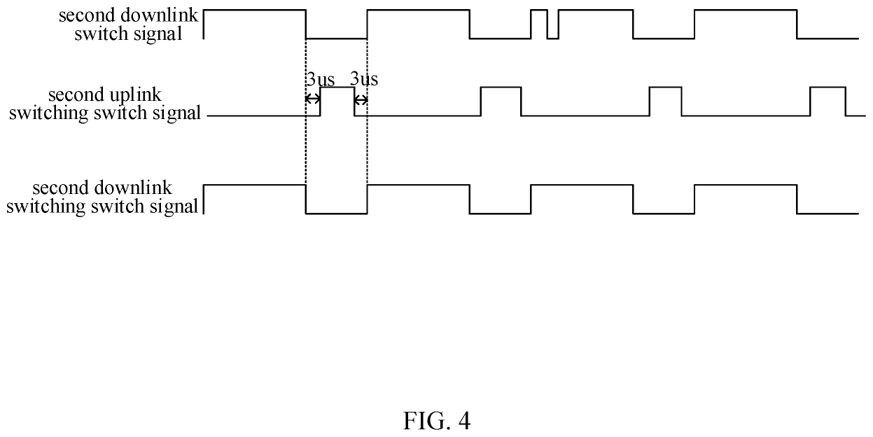

For example, as shown in FIG. 4, in this embodiment, it is shown that in response to that the number of abnormal values between the downlink TDD switch signal and the standard switch signal is zero, the downlink TDD switch signal is output as the downlink power switching signal directly. That is, the logic processing unit 121 can recover the second uplink power switching signal according to the second downlink power switching signal, and output the second uplink power switching signal by way of turning-on delayed for 3 us and turning-off in advance for 3 us following the 3GPP standard according to the 10 ms switch signal switching information provided by the embedded system 122, to achieve the noninterference between the uplink and downlink power switching signals.

In response to that the downlink TDD switch signal further includes an identification signal, the logic processing unit 121 outputs the first downlink power switching signal and the second downlink power switching signal of the downlink power switching signal according to the identification signal.

Alternatively, in response to that the identification signal includes a first identification signal and a second identification signal, the logic processing unit 121 outputs the first downlink power switching signal and the second downlink power switching signal of the downlink power switching signal according to the first identification signal and the second identification signal.

In addition, when the number of abnormal values between the downlink TDD switch signal and the standard switch signal is greater than or equal to the set value N, the logic processing unit 121 sends an abnormal warning to the embedded system 122.

The technical solution disclosed in the present disclosure can transmit a downlink TDD switch signal including a first downlink switch signal and a second downlink switch signal, and achieve the transmission for compatible with two types of TDD switch signals by the power-on detection, outputting the first downlink power switching signal, the first uplink power switching signal, the second downlink power switching signal, and the second uplink power switching signal synchronously. Further, by introducing the operation of relatively turning-on delay and turning-off in advance of the output of the uplink power switching signal and the corresponding downlink power switching signal, the uplink and downlink power switching signals will not be turned on synchronously and will not interfere with each other. In addition, the error correction function of the switch signal is achieved using the comparison between the high-level length and the low-level length of the switch signal and the threshold value in real time and the calibration of the switch signal.

It should be noted that although several assemblies or sub-assemblies of the device are mentioned in the above detailed description, this division is only exemplary and not mandatory. In fact, according to the embodiment(s) of the present disclosure, the features and functions of two or more assemblies described above may be embodied in one assembly. Conversely, the features and functions of one device described above can be further divided into multiple assemblies to be embodied.

The above are only optional embodiment(s) of the embodiment(s) of the present disclosure, and are not used to limit the embodiment(s) of the present disclosure. For those skilled in the art, the embodiment(s) of the present disclosure may have various modifications and changes. Any modification, equivalent replacement, improvement, etc. made within the spirit and principle of the embodiment(s) of the present disclosure should be included in the protection scope of the embodiment(s) of the present disclosure.

Although the embodiment(s) of the present disclosure have been described with reference to several specific embodiment(s), it should be understood that the embodiment(s) of the present disclosure are not limited to the specific embodiment(s) disclosed. The embodiment(s) of the present disclosure are intended to cover various modifications and equivalent arrangements included within the spirit and scope of the appended claims. The scope of the appended claims accords with the broadest interpretation, so as to include all such modifications and equivalent structures and functions.

1. A remote device for transmission compatible with two types of Time Division Duplex (TDD) switch signals, the remote device comprising: a logic processing unit and an embedded system,
the logic processing unit being configured to receive a downlink TDD switch signal, wherein the downlink TDD switch signal comprises a first downlink switch signal and a second downlink switch signal;
the embedded system being configured to:
perform a power-on detection on the downlink TDD switch signal;
in response to a successful power-on detection, generate a standard switch signal corresponding to the downlink TDD switch signal;
the logic processing unit being further configured to:
receive information indicating the successful power-on detection and the standard switch signal;
compare the downlink TDD switch signal with the standard switch signal;
in response to that a number of abnormal values between the downlink TDD switch signal and the standard switch signal is less than a set value N, output a first downlink power switching signal, a first uplink power switching signal, a second downlink power switching signal, and a second uplink power switching signal related to the downlink TDD switch signal.

2. The remote device according to claim 1, wherein the embedded system is further configured to:
receive a plurality of the downlink TDD switch signals in a first sampling period as a plurality of test downlink TDD switch signals;
determine whether numbers of transition edges of the plurality of test downlink TDD switch signals are equal to each other, and in response to that the numbers of transition edges are equal, generate a signal average value of the plurality of test downlink TDD switch signals, wherein each test downlink TDD switch signal comprises multiple high-levels and multiple low-levels, and the signal average value is a set of average values of all high-levels and low-levels in corresponding positions of the plurality of test downlink TDD switch signals;
determine whether a first difference between each test downlink TDD switch signal and the signal average value is lower than a first threshold;
in response to that each first difference between each test downlink TDD switch signal and the signal average value is lower than the first threshold, determine that the power-on detection is successful.

3. The remote device according to claim 2, wherein if the power-on detection is successful, the embedded system is further configured to
use the signal average value as the standard switch signal.

4. The remote device according to claim 3, wherein the logic processing unit is further configured to:
determine whether a number of all transition edges of the downlink TDD switch signal in a second sampling period is equal to a number of all transition edges of the standard switch signal, and if not, record that there is one abnormal value in the downlink TDD switch signal, wherein the second sampling period and the first sampling period have a same duration;
determine whether a plurality of second differences between each high-level and each low-level of the downlink TDD switch signal in the second sampling period and the corresponding high-level and low-level of the standard switch signal exceed a second threshold value, if the second difference exceeds the second threshold value, record that there is one abnormal value in the downlink TDD switch signal.

5. The remote device according to claim 4, wherein the logic processing unit is further configured to:
in response to that the number of abnormal values between the downlink TDD switch signal and the standard switch signal is zero, directly output the downlink TDD switch signal as a downlink power switching signal; or
in response to that the number of abnormal values between the downlink TDD switch signal and the standard switch signal is less than the set value N, output the standard switch signal as the downlink power switching signal.

6. The remote device according to claim 5, wherein the logic processing unit is further configured to:
recover an uplink power switching signal according to the downlink power switching signal;
perform operations of turning-on delay and turning-off in advance on an output of the uplink power switching signal and the corresponding downlink power switching signal.

7. The remote device according to claim 6, wherein the logic processing unit is further configured to:
in response to that the downlink TDD switch signal further comprises an identification signal, output the first downlink power switching signal and the second downlink power switching signal of the downlink power switching signal according to the identification signal.

8. The remote device according to claim 7, wherein the logic processing unit is further configured to: in response to that the identification signal includes the first identification signal and a second identification signal, output the first downlink power switching signal and the second downlink power switching signal of the downlink power switching signal according to the first identification signal and the second identification signal.

9. A system for transmission compatible with two types of TDD switch signals, the system comprising:
a remote device; and
a near-end device configured to send a downlink TDD switch signal to the remote device, wherein the downlink TDD switch signal comprises a first downlink switch signal and a second downlink switch signal,
wherein the remote device comprises:
a logic processing unit configured to receive the downlink TDD switch signal; and
an embedded system configured to: perform a power-on detection on the downlink TDD switch signal; and in response to a successful power-on detection, generate a standard switch signal corresponding to the downlink TDD switch signal; and
the logic processing unit is further configured to:
receive information indicating the successful power-on detection and the standard switch signal;
compare the downlink TDD switch signal with the standard switch signal; and
in response to that a number of abnormal values between the downlink TDD switch signal and the standard switch signal is less than a set value N, output a first downlink power switching signal, a first uplink power switching signal, a second downlink power switching signal, and a second uplink power switching signal related to the downlink TDD switch signal.

10. A method for transmission compatible with two types of TDD switch signals, the method comprising:
providing a remote device, wherein the remote device comprises a logic processing unit receiving a downlink TDD switch signal and an embedded system, wherein the downlink TDD switch signal comprises a first downlink switch signal and a second downlink switch signal;
performing a power-on detection on the downlink TDD switch signal by the embedded system;
in response to a successful power-on detection, generating a standard switch signal corresponding to the downlink TDD switch signal by the embedded system;
comparing the downlink TDD switch signal with the standard switch signal by the logic processing unit; and
in response to that the number of abnormal values between the downlink TDD switch signal and the standard switch signal is less than a set value N, outputting a first downlink power switching signal, a first uplink power switching signal, a second downlink power switching signal, and a second uplink power switching signal related to the downlink TDD switch signal by the logic processing unit.

11. The method according to claim 10, wherein performing a power-on detection on the downlink TDD switch signal by the embedded system further comprises:
receiving a plurality of downlink TDD switch signals in a first sampling period as a plurality of test downlink TDD switch signals;
determining whether numbers of transition edges of the plurality of test downlink TDD switch signals are equal to each other, and in response to that the numbers of transition edges are equal, generating a signal average value of the plurality of test downlink TDD switch signals, wherein each test downlink TDD switch signal comprises multiple high-levels and multiple low-levels, and the signal average value is a set of average values of all high-levels and low-levels in corresponding positions of the plurality of test downlink TDD switch signals;
determining whether a first difference between each test downlink TDD switch signal and the signal average value is lower than a first threshold;
in response to that each first difference between each test downlink TDD switch signal and the signal average value is lower than the first threshold, determining that the power-on detection is successful.

12. The method according to claim 11, wherein generating the standard switch signal corresponding to the downlink TDD switch signal by the embedded system further comprises:
using the signal average value as the standard switch signal.

13. The method of claim 12, wherein comparing the downlink TDD switch signal with the standard switch signal by the logic processing unit further comprises:
determining whether a number of all transition edges of the downlink TDD switch signal in a second sampling period is equal to a number of all transition edges of the standard switch signal, and if not, recording that there is one abnormal value in the downlink TDD switch signal, wherein the second sampling period and the first sampling period have a same duration;
determining whether a plurality of second differences between each high-level and each low-level of the downlink TDD switch signal in the second sampling period and the corresponding high-level and low-level of the standard switch signal exceed a second threshold value, if the second difference exceeds the second threshold value, recording that there is one abnormal value in the downlink TDD switch signal.

14. The method according to claim 13, wherein in response to that a number of abnormal values between the downlink TDD switch signal and the standard switch signal is less than a set value of N, outputting the first downlink power switching signal, the first uplink power switching signal, the second downlink power switching signal, and the second uplink power switching signal by the logic processing unit further comprises:
in response to that the number of abnormal values between the downlink TDD switch signal and the standard switch signal is zero, directly outputting the downlink TDD switch signal as a downlink power switching signal; or
in response to that the number of abnormal values between the downlink TDD switch signal and the standard switch signal is less than the set value N, outputting the standard switch signal as the downlink power switching signal.

15. The method according to claim 14, wherein outputting the first downlink power switching signal, the first uplink power switching signal, the second downlink power switching signal, and the second uplink power switching signal by the logic processing unit further comprises:
recovering the uplink power switching signal according to the downlink power switching signal;
performing operations of turning-on delay and turning-off in advance on the output of the uplink power switching signal and the corresponding downlink power switching signal.

16. The method according to claim 15, wherein outputting the first downlink power switching signal, the first uplink power switching signal, the second downlink power switching signal, and the second uplink power switching signal by the logic processing unit further comprises:
in response to that the downlink TDD switch signal further comprises an identification signal, outputting the first downlink power switching signal and the second downlink power switching signal of the downlink power switching signal according to the identification signal.

17. The method according to claim 16, wherein outputting the first downlink power switching signal, the first uplink power switching signal, the second downlink power switching signal, and the second uplink power switching signal by the logic processing unit further comprises:
in response to that the identification signal includes the first identification signal and a second identification signal, outputting the first downlink power switching signal and the second downlink power switching signal of the downlink power switching signal according to the first identification signal and the second identification signal.
